(19) United States
(12) Patent Application Publication
(10) Pub. No.: US 2025/0087002 A1
(43) Pub. Date: Mar. 13, 2025

(54) METHOD AND SYSTEM FOR IDENTIFYING PRODUCT DETAILS FROM MARKETING COLLATERAL IMAGES

(71) Applicant: Tata Consultancy Services Limited, Mumbai (IN)

(72) Inventors: Amit Kumar AGRAWAL, Kolkata (IN); Devang Jagdishchandra PATEL, Mumbai (IN); Gunjan AGRAWAL, Bangalore (IN); Pushp Kumar JAIN, Pune (IN); Prosenjit MONDAL, Kolkata (IN); Mantu Prasad GUPTA, Telangana (IN)

(73) Assignee: Tata Consultancy Services Limited, Mumbai (IN)

(21) Appl. No.: 18/796,739

(22) Filed: Aug. 7, 2024

(30) Foreign Application Priority Data
Sep. 7, 2023 (IN) 202321060137

(51) Int. Cl. G06V 30/18; G06Q 30/0201; G06V 30/148

(52) U.S. Cl. CPC G06V 30/18; G06Q 30/0201; G06V 30/148

(57) ABSTRACT

Retailers need information about their competitor's pricing and promotions and marketing collaterals are one of the most vital sources of this information. Conventional approaches for extracting product names from marketing collaterals depends on large volume of data repositories and complex machine learning based approaches. The present disclosure extracts product name blocks from marketing collaterals using image processing techniques. The inputs to the present disclosure are seed words and the marketing collateral. A plurality of word level text regions from the image and text value are obtained. Further, a plurality of text characteristics corresponding to each of the plurality of word level text regions are extracted and matching seed word regions are obtained. Further a plurality of meaningful text blocks and a plurality of seed blocks are obtained. Finally, a plurality of product names are extracted using a matrix based product name detection technique and updated in the product dictionary.

### PRIORITY CLAIM

This application claims priority from International application No. 202321060137, filed on Sep. 7, 2023. The entire contents of the aforementioned application are incorporated herein by reference.

### TECHNICAL FIELD

The disclosure herein generally relates to the field of image processing and, more particularly, to a method and system for identifying product details from marketing collateral images.

### BACKGROUND

Retailers need complete information about their competitor's pricing and promotions to make sure that they are competitive enough to attract the customers. Marketing collaterals like product flyers and brochures are one of the most vital sources of this information. The identification of product names and their associated details from marketing collaterals is of paramount importance due to the comprehensive information they provide. This includes crucial aspects such as the brand name, specific product name, quantity, and other pertinent details related to the product.

Conventional approaches depend on large volume of data repositories which consists of grammatical words, common English words, different sets of keywords like category keywords, brand names, brand-specific product names which needs to be manually prepared or hand crafted. Further, most of the prior arts are based on conditional random field models, Support Vector Machine (SVM), etc. which requires large volume of feature specific training data along with metadata, performance of the model depends on quality and quantity of the training data. Few conventional approaches utilize Name Entity Recognition (NER) methods which requires large amount of annotated training data, and some other conventional approaches utilize different sorts of computation like word2vec, Term Frequency-Inverse Document Frequency (TF-IDF), etc. which requires a large corpus of targeted data for optimal performance. Another set of conventional approaches are template based and assume that product name follows certain grammatical patterns. Thus, the conventional approaches have the above mentioned limitations that need to be addressed for obtaining product details from marketing collateral in an efficient manner.

### SUMMARY

Embodiments of the present disclosure present technological improvements as solutions to one or more of the above-mentioned technical problems recognized by the inventors in conventional systems. For example, in one embodiment, a method for identifying product details from marketing collateral images is provided. The method includes receiving, by one or more hardware processors, an image and a plurality of seed words associated with a marketing collateral. Further, the method includes identifying a plurality of word level text regions from the image using a text region detection technique. Furthermore, the method includes extracting a text value corresponding to each of the plurality of word level text regions using a text extraction technique. Furthermore, the method includes extracting a plurality of text characteristics corresponding to each of the plurality of word level text regions using a text characteristics extraction technique. Furthermore, the method includes obtaining a plurality of matching seed word regions based on a comparison between the plurality of seed words and a plurality of text values corresponding to each of the plurality of word level text regions based on a Levenshtein distance based matching technique. Furthermore, the method includes identifying a plurality of meaningful text blocks by merging a plurality of adjacent word level text regions. Furthermore, the method includes identifying a plurality of seed blocks by finding a merged word level text region overlapping with each of a corresponding plurality of matching seed word region. Finally, the method includes identifying a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

In another aspect, a system for identifying product details from marketing collateral images is provided. The system includes at least one memory storing programmed instructions, one or more Input/Output (I/O) interfaces, and one or more hardware processors operatively coupled to the at least one memory, wherein the one or more hardware processors are configured by the programmed instructions to receive an image and a plurality of seed words associated with a marketing collateral. Further, the one or more hardware processors are configured by the programmed instructions to identify a plurality of word level text regions from the image using a text region detection technique. Furthermore, the one or more hardware processors are configured by the programmed instructions to extract a text value corresponding to each of the plurality of word level text regions using a text extraction technique. Furthermore, the one or more hardware processors are configured by the programmed instructions to extract a plurality of text characteristics corresponding to each of the plurality of word level text regions using a text characteristics extraction technique. Furthermore, the one or more hardware processors are configured by the programmed instructions to obtain a plurality of matching seed word regions based on a comparison between the plurality of seed words and a plurality of text values corresponding to each of the plurality of word level text regions based on a Levenshtein distance based matching technique. Furthermore, the one or more hardware processors are configured by the programmed instructions to identify a plurality of meaningful text blocks by merging a plurality of adjacent word level text regions. Furthermore, the one or more hardware processors are configured by the programmed instructions to identify a plurality of seed blocks by finding a merged word level text region overlapping with each of a corresponding plurality of matching seed word region. Finally, the one or more hardware processors are configured by the programmed instructions to identify a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

In yet another aspect, a computer program product including a non-transitory computer-readable medium having embodied therein a computer program for identifying product details from marketing collateral images is provided. The computer readable program, when executed on a computing device, causes the computing device to receive an image and a plurality of seed words associated with a marketing collateral. Further, computer readable program, when executed on a computing device, causes the computing device to identify a plurality of word level text regions from the image using a text region detection technique. Furthermore, the computer readable program, when executed on a computing device, causes the computing device to extract a text value corresponding to each of the plurality of word level text regions using a text extraction technique. Furthermore, the computer readable program, when executed on a computing device, causes the computing device to extract a plurality of text characteristics corresponding to each of the plurality of word level text regions using a text characteristics extraction technique. Furthermore, the computer readable program, when executed on a computing device, causes the computing device to obtain a plurality of matching seed word regions based on a comparison between the plurality of seed words and a plurality of text values corresponding to each of the plurality of word level text regions based on a Levenshtein distance based matching technique. Furthermore, the computer readable program, when executed on a computing device, causes the computing device to identify a plurality of meaningful text blocks by merging a plurality of adjacent word level text regions. Furthermore, the computer readable program, when executed on a computing device, causes the computing device to identify a plurality of seed blocks by finding a merged word level text region overlapping with each of a corresponding plurality of matching seed word region. Finally, the computer readable program, when executed on a computing device, causes the computing device to identify a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for identifying product details from marketing collateral images, in accordance with some embodiments of the present disclosure.

FIG. 2 illustrates a functional architecture of the system of FIG. 1, for identifying product details from marketing collateral images, in accordance with some embodiments of the present disclosure.

FIG. 3 is an exemplary flow diagram illustrating a processor implemented method for identifying product details from marketing collateral images implemented by the system of FIG. 1 according to some embodiments of the present disclosure.

FIG. 4 is an example marketing collateral for identifying product names according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Retailers need complete information about their competitor's pricing and promotions to make sure that they are competitive enough to attract the customers. Marketing collaterals like product flyers and brochures are one of the most vital sources of this information. The identification of product names and their associated details from marketing collaterals is of paramount importance due to the comprehensive information they provide. This includes crucial aspects such as the brand name, specific product name, quantity, and other pertinent details related to the product. Some of the conventional approaches utilizes conditional random field models, Support Vector Machine (SVM), Name Entity Recognition (NER) techniques for extraction of product details from marketing collaterals like brochures, complex retail flyer images or PDFs and the said conventional approaches require feature specific training data.

Some other conventional approaches depend on larger volume of data repositories which consists of grammatical words, common English words, different sets of keywords like category keywords, brand names, brand-specific product names which should be manually prepared or hand crafted. Most of the conventional methods are template based and requires bulk data. Also, the current state of art deep/machine learning based methods require a lot of training data (Which are costly and difficult to gather), and high-end GPU compute infrastructure.

To overcome the challenges of the conventional approaches, embodiments herein provide an image processing system, and more particularly to a system and method to identify product details and generate a product name dictionary from a complex retail flyer image. The present disclosure extracts product name blocks from marketing collaterals using image processing techniques. The inputs to the present disclosure are seed words and the marketing collateral (for example, flyers, brochures, and the like). The seed words are valid product names taken from the input flyer and its purpose is to identify other product names having similar textual characteristics. It involves various stages of image processing steps for detecting and extracting product information and creating product name training dictionary. The inputs to the present disclosure are seed words and the marketing collateral. A plurality of word level text regions from the image and text value are obtained. Further, a plurality of text characteristics corresponding to each of the plurality of word level text regions are extracted and matching seed word regions are obtained. Further a plurality of meaningful text blocks and a plurality of seed blocks are obtained. Finally, a plurality of product names are extracted using a matrix based product name detection technique and updated in the product dictionary. The product name dictionary is created with minimal effort, irrespective of its language and thus makes the method language agnostic. The method and system are generic in nature and thus can be implemented to generate product training data from any complex retail flyer images using a set of image processing techniques.

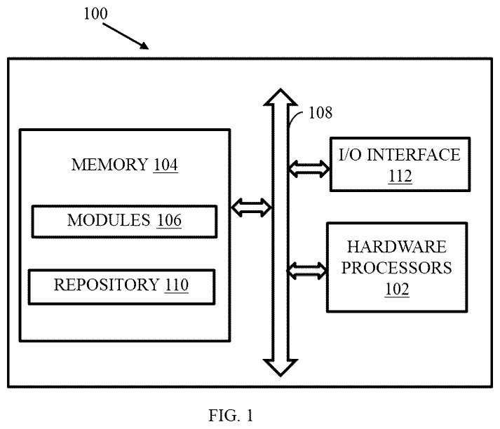

Referring now to the drawings, and more particularly to FIGS. 1 through 4, where similar reference characters denote corresponding features consistently throughout the figures, there are shown preferred embodiments and these embodiments are described in the context of the following exemplary system and/or method.

FIG. 1 is a functional block diagram of a system 100 for identifying product details from marketing collateral images, in accordance with some embodiments of the present disclosure. The system 100 includes or is otherwise in communication with hardware processors 102, at least one memory such as a memory 104, an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may further include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

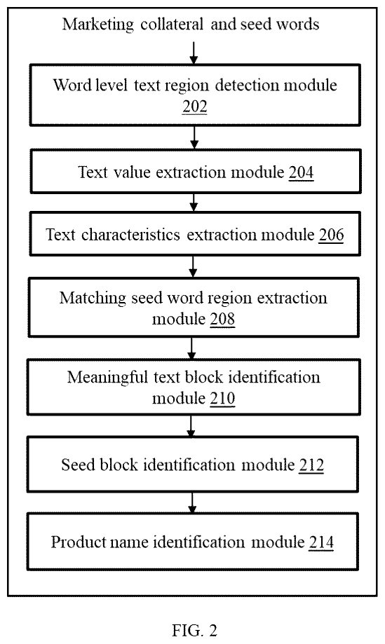

The plurality of modules 106 include programs or coded instructions that supplement applications or functions performed by the system 100 for identifying product details from marketing collateral images. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for identifying product details from marketing collateral images. In an embodiment, the plurality of modules 106 include a word level text region detection module 202 (shown in FIG. 2), a text value extraction module 204, a text characteristics extraction module 206 (shown in FIG. 2), a matching seed word region extraction module 208 (shown in FIG. 2), a meaningful text block identification module 210 (shown in FIG. 2), a seed block identification module 212 (shown in FIG. 2), a product name identification module 214 (shown in FIG. 2). In an embodiment, FIG. 2 illustrates a functional architecture of the system of FIG. 1, for identifying product details from marketing collateral images, in accordance with some embodiments of the present disclosure.

The data repository (or repository) 110 may include a plurality of abstracted piece of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such an external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS).

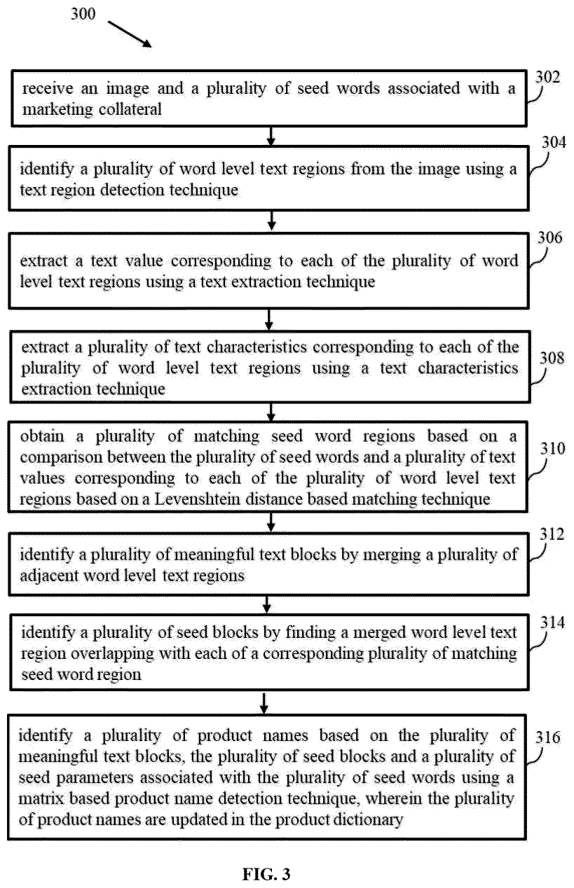

FIG. 3 is an exemplary flow diagram illustrating a method 300 for identifying product details from marketing collateral images implemented by the system of FIG. 1 according to some embodiments of the present disclosure. In an embodiment, the system 100 includes one or more data storage devices or the memory 104 operatively coupled to the one or more hardware processor(s) 102 and is configured to store instructions for execution of steps of the method 300 by the one or more hardware processors 102. The steps of the method 300 of the present disclosure will now be explained with reference to the components or blocks of the system 100 as depicted in FIG. 1 and the steps of flow diagram as depicted in FIG. 3. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. The order in which the method 300 is described is not intended to be construed as a limitation, and any number of the described method blocks can be combined in any order to implement the method 300, or an alternative method. Furthermore, the method 300 can be implemented in any suitable hardware, software, firmware, or combination thereof.

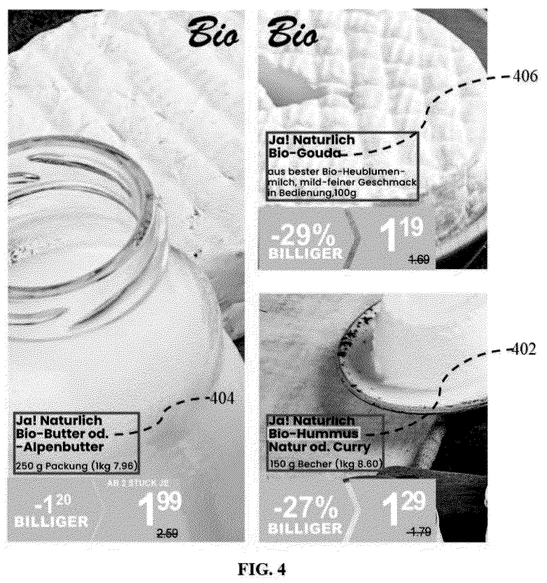

At step 302 of the method 300, the one or more hardware processors 102 are configured by the programmed instructions to receive an image and a plurality of seed words associated with a marketing collateral. For example, the marketing collateral includes a variety of formats ranging from flyers, brochures and the like. The seed words are valid product names associated with the marketing collateral used for identifying other product names. For example, considering FIG. 4, if the seed word is “Bio-Hummus®” 402, then the product names are “Bio-Butter Od®” 404 and “Bio-Gouda®” 406.

At step 304 of the method 300, the word level text region detection module 202 executed by one or more hardware processors 102 is configured by the programmed instructions to identify a plurality of word level text regions from the image using a text region detection technique. For example, the text region detection technique used in the present disclosure can be one of the state of the art text detection techniques.

At step 306 of the method 300, the text value extraction module 204 executed by the one or more hardware processors 102 is configured by the programmed instructions to extract a text value corresponding to each of the plurality of word level text regions using a text extraction technique. For example, any state of the art OCR techniques can be used for the text value extraction.

At step 308 of the method 300, the text characteristics extraction module 206 executed by the one or more hardware processors 102 is configured by the programmed instructions to extract a plurality of text characteristics corresponding to each of the plurality of word level text regions using a text characteristics extraction technique. For example, the plurality of text characteristics includes a text pixel density, a foreground text color, and a height of the text region. The text characteristics extraction technique of the present disclosure explained as follows. Initially, each of the plurality of word level text regions are converted into a two-colour converted text regions using a two-colour conversion utility function. The two-colour conversion utility function used herein is in accordance with Applicant's Indian Patent Application number 202221029276, titled METHOD AND SYSTEM FOR DETECTING AND EXTRACTING PRICE REGION FROM A DIGITAL FLYERS AND PROMOTIONS, filed on 20 May 2022. Thus, it can be understood that explanation of two-colour conversion utility function is discussed briefly herein and can be referred to above application for further details. Further, a plurality of text regions are obtained by removing white pixel noise from the two-colour converted text regions using an image processing technique. Furthermore, a white pixel mask corresponding to each of the plurality of text regions is obtained using image processing tools, wherein the text region comprises a foreground text. After obtaining white pixel mask, a dominant color value is identified for each of the plurality of text regions by converting the each of the plurality of text regions into LAB color space and masking an L component with the white pixel mask. After identifying dominant color, a text pixel density associated with each of the plurality of text regions is estimated based on the white pixel mask. The text pixel density is the quotient obtained by dividing number of white pixels by total size of the text region and, wherein the total size of the text region is equal to total number of pixels in the text region. Further, a height associated with each of the plurality of text regions is computed based on a height of the white pixel mask associated with each of the plurality of text regions, wherein the height associated with each of the plurality of text regions corresponds to the maximum height of the foreground text. Finally, the plurality of text characteristics corresponding to each of the plurality of word level text regions are obtained by generating a tuple comprising the text pixel density, the foreground text color, and the height of the text region. An example text characteristic tuple for the product name “Bio-Gouda®” shown in FIG. 4 is (0.45, 7, 47).

In an embodiment, the text characteristic comparison utility used in the present disclosure analyzes the text characteristics of two word level text regions, taking into account a tolerance level referred to as TUPLE_THRESHOLD. The TUPLE_THRESHOLD includes threshold values for comparing the text pixel density, the foreground text color, and the height of the text region. Through experimentation, it was determined that the optimal TUPLE_THRESHOLD values are (0.10, 5, 10). An example pseudocode 1 for text characteristic comparison is given below:

### Pseudocode 1:

| | |
|---|---|
| i. | Let T1 and T2 be two text characteristics tuple corresponding to text |
| | regions. |
| ii. | IF \|T1.text_density − T2.text_density\| <= |
| | TUPLE_THRESHOLD.text_density AND \|T1.text_color − T2.text_color\| |
| | <= TUPLE_THRESHOLD.text_color |
| | AND \|T1.text_height − T2.text_height\| <= |

TUPLE_THRESHOLD.text_height

```
Then
    RETURN True
    ELSE
      RETURN False
```

At step 310 of the method 300, the matching seed word region extraction module 208 executed by the one or more hardware processors 102 is configured by the programmed instructions to obtain a plurality of matching seed word regions based on a comparison between the plurality of seed words and a plurality of text values corresponding to each of the plurality of word level text regions based on a Levenshtein distance based matching technique. For example, for every seed word from the plurality of seed words, Levenshtein Distance (fuzzy matching) of its text with each text value is calculated. If the Levenshtein Distance is less than certain pre-defined threshold, then the text characteristics of corresponding word level text regions are captured as seed word parameters and append it to SEED_PARAMETER_LIST.

At step 312 of the method 300, the meaningful text block identification module 210 executed by the one or more hardware processors 102 is configured by the programmed instructions to identify a plurality of meaningful text blocks by merging a plurality of adjacent word level text regions.

At step 314 of the method 300, the seed block identification module 212 executed by the one or more hardware processors 102 is configured by the programmed instructions to identify a plurality of seed blocks by finding a merged word level text region overlapping with each of a corresponding plurality of matching seed word region.

The pseudocode for identifying the plurality of meaningful text blocks, the plurality of seed blocks and computing minimum count value is explained using the following pseudocode 2.

### Pseudocode 2:

a) As text regions are identified in word level, merge the adjacent text regions to form meaningful text blocks say MERGED_REGION_LIST.
b) Find the merged text region which overlaps with seed words and store it in SEED_BLOCK_LIST.
c) For each SEED_BLOCK in SEED_BLOCK_LIST
   (i) Generate a square matrix A (third matrix) from pairwise comparison of text regions characteristics in SEED_BLOCK using Text Characteristics Comparison Utility
   (ii) Count the number of distinct rows in matrix A and append it in MIN_COUNT_BLOCK_LIST. This value will be the number of distinct text characteristics in SEED BLOCK.
d) Take minimum of MIN_COUNT_BLOCK_LIST, name it as MIN_COUNTS.

At step 316 of the method 300, the product name identification module 214 executed by the one or more hardware processors 102 is configured by the programmed instructions to identify a plurality of product names based on the plurality of meaningful text blocks, the plurality of seed blocks and a plurality of seed parameters associated with the plurality of seed words using a matrix based product name detection technique, wherein the plurality of product names are updated in the product dictionary. The plurality of seed parameters comprises a text pixel density, a foreground text color, and a height of the text region associated with each of a plurality of seed words.

The steps for identifying the plurality of product names based on the plurality of meaningful text blocks, the plurality of seed blocks and the plurality of seed parameters associated with the plurality of seed words using the matrix based product name detection technique explained as follows. Initially, a first matrix is generated for each of the plurality of meaningful text blocks based on a pairwise comparison between the plurality of text characteristics associated with each element of the merged text region using the text characteristics comparison utility. After generating the first matrix, a merged region distinct row count value is computed by counting a number of distinct rows associated with the first matrix corresponding to each of the plurality of meaningful text blocks. Further, a second matrix is generated for each element of the merged text region associated with each of the plurality of meaningful text blocks based on a comparison between the plurality of text characteristics associated with each element of the merged text region and the plurality of seed parameters associated with the plurality of seed words using a text characteristics comparison utility. After generating the second matrix, a plurality of probable product names are obtained by identifying a plurality of elements associated with the merged text region having non zero value in the second matrix. Finally, a plurality of product names are identified from the plurality of probable product names corresponding to each of the plurality of meaningful text blocks if the corresponding text value is one of a) a noun and b) a pronoun only if the merged region distinct row count value corresponding to each of the plurality of meaningful text blocks is greater than or equal to a minimum count value.

The pseudocode for identifying the plurality of product names is explained using the following pseudocode 3:

### Pseudocode 3:

a) For MERGED_REGION in MERGED_REGION_LIST
   i. Generate a square matrix A1 (first matrix) from pairwise comparison of word regions characteristics in MERGED_REGION using Text Characteristics Comparison Utility. Count the number of distinct rows in A1, name it as MERGED_REGION_DISTINCT_COUNT.
   ii. Generate a matrix B (the second matrix) by comparing text characteristics of each element of MERGED_REGION with text characteristics of each element of SEED_PARAMETER_LIST using Text Characteristics Comparison Utility. B_ij element will correspond to the result of comparison of ith MERGED_REGION with jth SEED_PARAMATER.
   iii. IF MERGED_REGION_DISTINCT_COUNT is greater than equal to MIN_COUNTS AND any element of B (second matrix) is TRUE,
      THEN
         FOR each word region in MERGED_REGION having B entry as True
         IF its TEXT_VALUE (text value) is Noun OR
         Pronoun
         THEN
         insert TEXT_VALUE in Product Name
         Dictionary
         append MERGED_REGION in SELECTED_MERGED_REGION_LIST.
      ELSE CONTINUE.
b) OUTPUT SELECTED_MERGED_REGION_LIST as Product Name Block and Updated Product Name Dictionary.

The steps for computing the minimum count value based on the plurality of seed blocks are explained as follows: Initially, a third matrix is generated for each of the plurality of seed blocks based on a pairwise comparison of a corresponding plurality of text characteristics associated with each of the plurality of seed blocks using the text characteristics comparison utility. Further, a distinct row count list is generated based on the associated third matrix corresponding to each of the plurality of seed blocks. Finally, the minimum count value is identified by selecting a top value from a sorted distinct row count list, wherein the distinct row count list is sorted in ascending order as explained in Pseudocode 2.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the unresolved problem of identifying product details/product names from marketing collateral images. The present disclosure identifies the product name blocks from marketing collateral using a novel matrix based product name detection technique and prepare the product name dictionary with minimal effort. Further, the present disclosure is a generic approach that can extract product name information from complex marketing collateral images. It is a non-template-based approach that doesn't expect product names in a predefined region or containing certain grammatical patterns. It can detect and extract product names irrespective of their color, style etc. Further, the present disclosure doesn't require any type of training data such as data repositories of brand names & grammatical words, feature specific training data, annotated training data etc. The present disclosure is language agnostic and can work with any marketing collateral image irrespective of its language. The present disclosure utilizes an unique approach of representative seed words as input, to identify product names in the marketing collateral image.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving, by one or more hardware processors, an image and a plurality of seed words associated with a marketing collateral;
identifying, by the one or more hardware processors, a plurality of word level text regions from the image using a text region detection technique;
extracting, by the one or more hardware processors, a text value corresponding to each of the plurality of word level text regions using a text extraction technique;
extracting, by the one or more hardware processors, a plurality of text characteristics corresponding to each of the plurality of word level text regions using a text characteristics extraction technique;
obtaining, by the one or more hardware processors, a plurality of matching seed word regions based on a comparison between the plurality of seed words and a plurality of text values corresponding to each of the plurality of word level text regions based on a Levenshtein distance based matching technique;
identifying, by the one or more hardware processors, a plurality of meaningful text blocks by merging a plurality of adjacent word level text regions;
identifying, by the one or more hardware processors, a plurality of seed blocks by finding a merged word level text region overlapping with each of a corresponding plurality of matching seed word region; and
identifying, by the one or more hardware processors, a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

2. The processor implemented method of claim 1, wherein the plurality of text characteristics comprises a text pixel density, a foreground text color, and a height of the text region.

3. The processor implemented method of claim 1, wherein the plurality of seed parameters comprises a text pixel density, a foreground text color, and a height of the text region.

4. The processor implemented method of claim 1, wherein the seed words are valid product names associated with the marketing collateral used for identifying other product names.

5. The processor implemented method of claim 1, wherein the steps for extracting the plurality of text characteristics from the marketing collateral based on the plurality of word level text regions using the text characteristics extraction technique comprises:
converting each of the plurality of word level text regions into a two-colour converted text regions using a two-colour conversion utility function;
obtaining a plurality of text regions by removing white pixel noise from the two-colour converted text regions using an image processing technique;
obtaining a white pixel mask corresponding to each of the plurality of text regions using image processing tools, wherein the text region comprises a foreground text;
identifying a dominant color value for each of the plurality of text regions by converting the each of the plurality of text regions into LAB color space and masking an L component with the white pixel mask;
estimating a text pixel density associated with each of the plurality of text regions based on the white pixel mask, wherein the text pixel density is the quotient obtained by dividing number of white pixels by total size of the text region and, wherein the total size of the text region is equal to total number of pixels in the text region;
computing a height associated with each of the plurality of text regions based on a height of the white pixel mask associated with each of the plurality of text regions, wherein the height associated with each of the plurality of text regions corresponds to the maximum height of the foreground text; and
obtaining the plurality of text characteristics corresponding to each of the plurality of word level text regions by generating a tuple comprising the text pixel density, the foreground text color, and the height of the text region.

6. The processor implemented method of claim 1, wherein the steps for identifying the plurality of product names based on the plurality of meaningful text blocks, the plurality of seed blocks and the plurality of seed parameters associated with the plurality of seed words using the matrix based product name detection technique comprises:
generating a first matrix for each of the plurality of meaningful text blocks based on a pairwise comparison between the plurality of text characteristics associated with each element of the merged text region using the text characteristics comparison utility;
computing a merged region distinct row count value by counting a number of distinct rows associated with the first matrix corresponding to each of the plurality of meaningful text blocks;
generating a second matrix for each element of the merged text region associated with each of the plurality of meaningful text blocks based on a comparison between the plurality of text characteristics associated with each element of the merged text region and the plurality of seed parameters associated with the plurality of seed words using a text characteristics comparison utility;
obtaining a plurality of probable product names by identifying a plurality of elements associated with the merged text region having non-zero value in the second matrix; and
identifying a plurality of product names from the plurality of probable product names corresponding to each of the plurality of meaningful text blocks if the corresponding text value is one of a) a noun and b) a pronoun only if the merged region distinct row count value corresponding to each of the plurality of meaningful text blocks is greater than or equal to a minimum count value.

7. The processor implemented method of claim 6, wherein the steps for computing the minimum count value based on the plurality of seed blocks comprises:
generating a third matrix for each of the plurality of seed blocks based on a pairwise comparison of a corresponding plurality of text characteristics associated with each of the plurality of seed blocks using the text characteristics comparison utility;
generating a distinct row count list based on the associated third matrix corresponding to each of the plurality of seed blocks; and
identifying the minimum count value by selecting a top value from a sorted distinct row count list, wherein the distinct row count list is sorted in ascending order.

8. A system comprising:
at least one memory storing programmed instructions; one or more Input/Output (I/O) interfaces; and one or more hardware processors operatively coupled to the at least one memory, wherein the one or more hardware processors are configured by the programmed instructions to:
receive an image and a plurality of seed words associated with a marketing collateral;
identify a plurality of word level text regions from the image using a text region detection technique;
extract a text value corresponding to each of the plurality of word level text regions using a text extraction technique;
extract a plurality of text characteristics corresponding to each of the plurality of word level text regions using a text characteristics extraction technique;
obtain a plurality of matching seed word regions based on a comparison between the plurality of seed words and a plurality of text values corresponding to each of the plurality of word level text regions based on a Levenshtein distance based matching technique;
identify a plurality of meaningful text blocks by merging a plurality of adjacent word level text regions;
identify a plurality of seed blocks by finding a merged word level text region overlapping with each of a corresponding plurality of matching seed word region; and
identify a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

9. The system of claim 8, wherein the plurality of text characteristics comprises a text pixel density, a foreground text color, and a height of the text region.

10. The system of claim 8, wherein the plurality of seed parameters comprises a text pixel density, a foreground text color, and a height of the text region.

11. The system of claim 8, wherein the seed words are valid product names associated with the marketing collateral used for identifying other product names.

12. The system of claim 8, wherein the steps for extracting the plurality of text characteristics from the marketing collateral based on the plurality of word level text regions using the text characteristics extraction technique comprises:
converting each of the plurality of word level text regions into a two-colour converted text regions using a two-colour conversion utility function;
obtaining a plurality of text regions by removing white pixel noise from the two-colour converted text regions using an image processing technique;
obtaining a white pixel mask corresponding to each of the plurality of text regions using image processing tools, wherein the text region comprises a foreground text;
identifying a dominant color value for each of the plurality of text regions by converting the each of the plurality of text regions into LAB color space and masking an L component with the white pixel mask;
estimating a text pixel density associated with each of the plurality of text regions based on the white pixel mask, wherein the text pixel density is the quotient obtained by dividing number of white pixels by total size of the text region and, wherein the total size of the text region is equal to total number of pixels in the text region;
computing a height associated with each of the plurality of text regions based on a height of the white pixel mask associated with each of the plurality of text regions, wherein the height associated with each of the plurality of text regions corresponds to the maximum height of the foreground text; and
obtaining the plurality of text characteristics corresponding to each of the plurality of word level text regions by generating a tuple comprising the text pixel density, the foreground text color, and the height of the text region.

13. The system of claim 8, wherein the steps for identifying the plurality of product names based on the plurality of meaningful text blocks, the plurality of seed blocks and the plurality of seed parameters associated with the plurality of seed words using the matrix based product name detection technique comprises:
generating a first matrix for each of the plurality of meaningful text blocks based on a pairwise comparison between the plurality of text characteristics associated with each element of the merged text region using the text characteristics comparison utility;
computing a merged region distinct row count value by counting a number of distinct rows associated with the first matrix corresponding to each of the plurality of meaningful text blocks;
generating a second matrix for each element of the merged text region associated with each of the plurality of meaningful text blocks based on a comparison between the plurality of text characteristics associated with each element of the merged text region and the plurality of seed parameters associated with the plurality of seed words using a text characteristics comparison utility;
obtaining a plurality of probable product names by identifying a plurality of elements associated with the merged text region having non-zero value in the second matrix; and
identifying a plurality of product names from the plurality of probable product names corresponding to each of the plurality of meaningful text blocks if the corresponding text value is one of a) a noun and b) a pronoun only if the merged region distinct row count value corresponding to each of the plurality of meaningful text blocks is greater than or equal to a minimum count value.

14. The system of claim 13, wherein the steps for computing the minimum count value based on the plurality of seed blocks comprises:
generating a third matrix for each of the plurality of seed blocks based on a pairwise comparison of a corresponding plurality of text characteristics associated with each of the plurality of seed blocks using the text characteristics comparison utility;
generating a distinct row count list based on the associated third matrix corresponding to each of the plurality of seed blocks; and
identifying the minimum count value by selecting a top value from a sorted distinct row count list, wherein the distinct row count list is sorted in ascending order.

15. One or more non-transitory machine-readable information storage mediums comprising one or more instructions which when executed by one or more hardware processors cause:
receiving an image and a plurality of seed words associated with a marketing collateral;
identifying a plurality of word level text regions from the image using a text region detection technique;
extracting a text value corresponding to each of the plurality of word level text regions using a text extraction technique;
extracting a plurality of text characteristics corresponding to each of the plurality of word level text regions using a text characteristics extraction technique;
obtaining a plurality of matching seed word regions based on a comparison between the plurality of seed words and a plurality of text values corresponding to each of the plurality of word level text regions based on a Levenshtein distance based matching technique;
identifying a plurality of meaningful text blocks by merging a plurality of adjacent word level text regions;
identifying a plurality of seed blocks by finding a merged word level text region overlapping with each of a corresponding plurality of matching seed word region; and
identifying a plurality of product names based on the plurality of meaningful text blocks, the plurality of seed blocks and a plurality of seed parameters associated with the plurality of seed words using a matrix based product name detection technique, wherein the plurality of product names are updated in the product dictionary.

16. The one or more non-transitory machine-readable information storage mediums of claim 15, wherein the plurality of text characteristics comprises a text pixel density, a foreground text color, and a height of the text region.

17. The one or more non-transitory machine-readable information storage mediums of claim 15, wherein the plurality of seed parameters comprises a text pixel density, a foreground text color, and a height of the text region.

18. The one or more non-transitory machine-readable information storage mediums of claim 15, wherein the seed words are valid product names associated with the marketing collateral used for identifying other product names.

19. The one or more non-transitory machine-readable information storage mediums of claim 15, wherein the steps for extracting the plurality of text characteristics from the marketing collateral based on the plurality of word level text regions using the text characteristics extraction technique comprises:
converting each of the plurality of word level text regions into a two-colour converted text regions using a two-colour conversion utility function;
obtaining a plurality of text regions by removing white pixel noise from the two-colour converted text regions using an image processing technique;
obtaining a white pixel mask corresponding to each of the plurality of text regions using image processing tools, wherein the text region comprises a foreground text;
identifying a dominant color value for each of the plurality of text regions by converting the each of the plurality of text regions into LAB color space and masking an L component with the white pixel mask;
estimating a text pixel density associated with each of the plurality of text regions based on the white pixel mask, wherein the text pixel density is the quotient obtained by dividing number of white pixels by total size of the text region and, wherein the total size of the text region is equal to total number of pixels in the text region;
computing a height associated with each of the plurality of text regions based on a height of the white pixel mask associated with each of the plurality of text regions, wherein the height associated with each of the plurality of text regions corresponds to the maximum height of the foreground text; and
obtaining the plurality of text characteristics corresponding to each of the plurality of word level text regions by generating a tuple comprising the text pixel density, the foreground text color, and the height of the text region.

20. The one or more non-transitory machine-readable information storage mediums of claim 15, wherein the steps for identifying the plurality of product names based on the plurality of meaningful text blocks, the plurality of seed blocks and the plurality of seed parameters associated with the plurality of seed words using the matrix based product name detection technique comprises:
generating a first matrix for each of the plurality of meaningful text blocks based on a pairwise comparison between the plurality of text characteristics associated with each element of the merged text region using the text characteristics comparison utility;
computing a merged region distinct row count value by counting a number of distinct rows associated with the first matrix corresponding to each of the plurality of meaningful text blocks;
generating a second matrix for each element of the merged text region associated with each of the plurality of meaningful text blocks based on a comparison between the plurality of text characteristics associated with each element of the merged text region and the plurality of seed parameters associated with the plurality of seed words using a text characteristics comparison utility;
obtaining a plurality of probable product names by identifying a plurality of elements associated with the merged text region having non-zero value in the second matrix; and
identifying a plurality of product names from the plurality of probable product names corresponding to each of the plurality of meaningful text blocks if the corresponding text value is one of a) a noun and b) a pronoun only if the merged region distinct row count value corresponding to each of the plurality of meaningful text blocks is greater than or equal to a minimum count value.
